(19) United States
(12) Patent Application Publication
(10) Pub. No.: US 2013/0027931 A1
(43) Pub. Date: Jan. 31, 2013

(54) LAMP AND ILLUMINATING DEVICE WITH LIGHT SOURCE OF SOLID STATE LIGHT EMITTING ELEMENT

(71) Applicants: Toshiaki Isogai, Osaka (JP); Kazushige Sugita, Hyogo (JP); Tatsumi Setomoto, Osaka (JP)

(72) Inventors: Toshiaki Isogai, Osaka (JP); Kazushige Sugita, Hyogo (JP); Tatsumi Setomoto, Osaka (JP)

(73) Assignee: PANASONIC CORPORATION, Osaka (JP)

(21) Appl. No.: 13/640,410

(22) PCT Filed: Mar. 2, 2011
(86) PCT No.: PCT/JP2011/001210

§ 371 Date: Oct. 10, 2012

(30) Foreign Application Priority Data
May 31, 2010 (JP) 2010-124824

(51) Int. Cl. F21V 21/00; F21V 7/00; F21V 8/00; F21V 11/00

(52) U.S. Cl. 362/235; 362/249.01

(57) ABSTRACT

A lamp including a solid-state light emitting element as a light source, includes a base, a light emitting module, and a drive circuit section. The base is attached to an external apparatus when the lamp is used, and is supplied with power. The light emitting module includes one or a plurality of solid-state light emitting elements. The drive circuit section lights the light emitting module by using power received from the base. The base, the light emitting module, and the drive circuit section are arranged in this order. The light emitting module is thermally connected to the base.

### TECHNICAL FIELD

The present invention relates to lamps which have built-in drive circuits and use, as light sources, solid-state light emitting elements such as LEDs (light emitting diode) or ELs (electroluminescence), and more specifically, to technologies for further improving the heat dissipation performance of drive circuits and light emitting modules.

### BACKGROUND ART

In recent years, in association with improvement of semiconductor technologies, there are increased demands for lamps which use solid-state light emitting elements as light sources.

The above lamps cause less power consumption and have long life, and thus greatly contribute to promotion of saving of energy and saving of resources. Therefore, it is expected that such lamps will prevail more and more in the future.

Here, Patent Literature 1 discloses a conventional bulb-shaped lamp which has a built-in drive circuit and uses, as a light source, a light emitting element such as an LED.

The bulb-shaped lamp of Patent Literature 1 includes a metallic enclosure member (corresponds to “lamp housing”) which has a peripheral part exposed to the outside and a recessed part formed inside the peripheral part, in which point light sources are installed to the peripheral part, circuit components are housed in the recessed part via an insulating member, a base is provided on the side of the opening edge part of the recessed part, and the point light sources are covered by a translucent cover attached to the enclosure member. In Patent Literature 1, it is described that, through the above configuration, heat conduction from the point light sources to the peripheral part is good and cooling performance for the point light sources is excellent, and accordingly, it is possible to effectively suppress heat increase in the point light sources.

### CITATION LIST

### Patent Literature

[PTL 1] Japanese Laid-Open Patent Publication No. 2006-313717

### SUMMARY OF THE INVENTION

### Problems to be Solved by the Invention

From the viewpoint of improving convenience, reducing material costs, and the like, there is a demand for downsizing a lamp which includes a solid-state light emitting element as a light source.

In a conventional bulb-shaped lamp such as in Patent Literature 1, a solid-state light emitting element, a drive circuit, and a base for power supply are arranged in this order. Accordingly, the drive circuit provided between the base for power supply and the solid-state light emitting element is in the way, and heat generated due to the solid-state light emitting element cannot be directly transmitted to the base to be dissipated. Thus, the heat is dissipated by using the enclosure member. Here, in order to realize a sufficient heat dissipation performance, it is necessary to ensure a sufficient envelope volume of the enclosure member. Thus, downsizing of the lamp is difficult. Moreover, since the size of the enclosure member is also restricted by the size of the drive circuit, downsizing of the lamp is difficult. Further, in the case of an existing bulb, light is emitted in almost all directions excluding the base portion. In contrast, in the case of a conventional bulb-shaped lamp having a large enclosure member, light from a light emitting element is greatly blocked by the enclosure member, and thus, it is difficult to emit light in all directions.

Further, since some of the heat generated in a solid-state light emitting element is dissipated to the outside via the drive circuit, a problem of heat increase in the drive circuit and the solid-state light emitting element associated, in particular, with downsizing and realization of high luminous flux becomes evident. This poses an issue of improving the heat dissipation performance.

Therefore, an object of the present invention is to provide a lamp including a solid-state light emitting element as a light source, and an illuminating device, in which the heat dissipation performance and the light-emitting characteristic are improved. In particular, an object of the present invention is to improve, in a lamp including a solid-state light emitting element as a light source and having a built-in drive circuit, the heat dissipation performance and the light-emitting-range characteristic thereof, by devising the arrangement of the drive circuit and the solid-state light emitting element.

### Solution to the Problems

The present invention is directed to a lamp including a solid-state light emitting element as a light source. In order to solve the above problems, the lamp including a solid-state light emitting element as a light source according to the present invention is a lamp including a solid-state light emitting element as a light source, which includes a base, a light emitting module, and a drive circuit. The base is configured to be attached to an external apparatus when the lamp is used and configured to be supplied with power. The light emitting module includes one or a plurality of solid-state light emitting elements. The drive circuit is configured to light the light emitting module by using power received from the base. The base, the light emitting module, and the drive circuit are arranged in this order, and the light emitting module is thermally connected to the base.

Further, the lamp including a solid-state light emitting element as a light source further includes a lamp housing and a globe. The lamp housing is made of a heat conduction material, has a cylindrical shape whose outer diameter decreases from one end to the other end, and is closed with a cover on a greater outer diameter side of the cylindrical shape. A light emitting module mounting face is provided on an upper face of the cover. The base is attached to the lamp housing on a smaller outer diameter side of the cylindrical shape. The globe is made of a translucent material and has a hollow spherical shape having an opening, the opening being connected to the lamp housing, on the light emitting module mounting face. The light emitting module is covered with the globe. The globe includes a diffusion film on an inner wall thereof. Here, the diameter of a maximum diameter portion of the globe may be greater than the diameter of a maximum diameter portion of the lamp housing.

Further, the lamp including a solid-state light emitting element as a light source may further include a supporting member, and the drive circuit may be installed by being fixed by the supporting member, in a hollow space, away from the base and the light emitting module, so as to block some of light emitted from the light emitting module.

Further, in the lamp including a solid-state light emitting element as a light source, the drive circuit may be surrounded by a circuit cover whose surface is formed by a reflective material.

Further, in the lamp including a solid-state light emitting element as a light source, the reflective material may have a reflectance of 80% or more in a wavelength range of light emitted from the light emitting module.

Further, in the lamp including a solid-state light emitting element as a light source, the supporting member may be formed by a plurality of stick-like supports, and one ends of the supports may be attached to the light emitting module mounting face so as to surround the light emitting module, and the other ends thereof may be attached to the circuit cover.

Further, in the lamp including a solid-state light emitting element as a light source, the drive circuit may be arranged on an axis passing through the base and the tip of the globe.

Further, the lamp further may include a supporting member, and the supporting member may be either one of a stick-like support and a translucent tube which each fix the drive circuit to the lamp housing, or either one of a prop and a translucent adhesive member which each fix the drive circuit to the inner wall of the globe.

Further, in the lamp including a solid-state light emitting element as a light source, the drive circuit may include a substrate and a circuit element mounted on the substrate, and a hole for allowing light pass therethrough may be formed in the substrate.

Further, in the lamp including a solid-state light emitting element as a light source, the drive circuit may include a substrate and a circuit element mounted on the substrate, and a base material of the substrate may have translucency.

Further, in the lamp including a solid-state light emitting element as a light source, the drive circuit includes a substrate and a circuit element mounted on the substrate, and the substrate is installed such that the mounting face thereof is substantially parallel to an emission direction of the light emitting module.

Further, the lamp including a solid-state light emitting element as a light source, the lamp further may include a light guide plate configured to guide some of light emitted from the light emitting module to a portion where light is blocked by the drive circuit.

Further, the lamp including a solid-state light emitting element as a light source may further include a globe having a light guiding function that guides some of light emitted from the light emitting module to a portion where light is blocked by the drive circuit.

Further, the lamp including a solid-state light emitting element as a light source may further include a second light emitting module configured to emit light to a portion where light is blocked by the drive circuit, and having an output smaller than that of the light emitting module.

The present invention is directed to an illuminating device including a lamp including a solid-state light emitting element as a light source, and an electric apparatus to which the lamp is attached and which supplies power from a commercial power source. In order to solve the above problems, the lamp including a solid-state light emitting element as a light source according to the present invention is a lamp including a solid-state light emitting element as a light source, which includes a base, a light emitting module, and a drive circuit. The base is configured to be attached to an external apparatus when the lamp is used, and is configured to be supplied with power. The light emitting module includes one or a plurality of solid-state light emitting elements. The drive circuit is configured to light the light emitting module by using power received from the base. The base, the light emitting module, and the drive circuit are arranged in this order, and the light emitting module is thermally connected to the base. The electric apparatus includes a socket to which the base is connected.

### Advantageous Effects of the Invention

As described above, in the lamp and the illuminating device of the present invention, it is possible to directly transmit, not via the drive circuit, heat generated by the light emitting module to the base, and to transmit the heat to an apparatus via a socket of the apparatus, thereby dissipating the heat. Conventionally, downsizing of the lamp housing is restricted in order to secure an envelope volume necessary for heat dissipation. However, the restriction is alleviated or eliminated, and thus, it is possible to downsize the overall size of the lamp.

Further, since heat is difficult to be transmitted to the drive circuit, heat burden to the drive circuit is reduced, and thus, improvement of durability of the drive circuit can be expected. Further, since there is no drive circuit between the light emitting module and the base, it is structurally easy to enhance the heat dissipation performance of the light emitting module. Further, since it is easy to provide the light emitting module near the base, it is possible to cause the globe to greatly project from near the base, whereby it is possible to make the light distribution characteristic close to that of a bulb.

In a conventional lamp including a solid-state light emitting element as a light source and having a built-in drive circuit, a drive circuit is often arranged between the light emitting module and the base. The configuration in which the drive circuit is installed at a position to the light emission side of the light emitting module as in the present invention is completely new. According to the configuration of the present invention, although some optical paths are blocked by the drive circuit, the light emitting module can be arranged closer to the base than in a conventional lamp, and thus, a large globe can be realized. Accordingly, it is possible to obtain an effect that the light distribution characteristic can be made closer to that of a bulb. In particular, no one seems to have conceived realization of the idea of installing the drive circuit in an upper portion including a portion right above the light emitting module, where the light distribution from the light emitting module is high, or in a wider sense, in a portion downstream from the light emission direction. This is because they believe that such a configuration would greatly decrease the luminous flux of the lamp or would cause unevenness in illuminance on the emission surface. Moreover, by realizing the supporting member for fixing the drive circuit to the hollow space by means of a stick-like structure or a translucent substance, it is also possible to reduce optical paths blocked by the supporting member. Further, by providing a reflection member on the surface of the drive circuit, it is possible to alleviate decrease of the luminous flux of the lamp due to the drive circuit.

Further, even in a state where there is no unevenness in illuminance on the emission surface, a portion darker than the other portions may remain on the globe, under influence of the drive circuit, which may cause unevenness in the brightness on the surface of the globe. This poses another problem of an unnatural appearance.

Thus, by devising the shape, arrangement, and material of the drive circuit, by installing a reflection member or a light guide plate, or by using a second light emitting module, it is possible to make inconspicuous a dark portion on the globe caused by influence of the drive circuit.

### BRIEF DESCRIPTION OF THE DRAWINGS

FIG. 1 shows an external view of a lamp 100 including a solid-state light emitting element as a light source according to a first embodiment.

FIG. 2(a) of FIG. 2 shows a cross section of LED elements respectively sealed with wavelength conversion members, and (b) of FIG. 2 shows a cross section of a plurality of LED elements collectively sealed with a wavelength conversion member.

FIG. 3(a) to (c) of FIG. 3 each show a specific example of how to arrange LED elements in a light emitting module 130.

FIG. 4 shows an external view of a lamp 200 including a solid-state light emitting element as a light source according to a first modification.

FIG. 5 shows an external view of a lamp 300 including a solid-state light emitting element as a light source according to a second modification.

FIG. 6 shows an external view of a lamp 400 including a solid-state light emitting element as a light source according to a third modification.

FIG. 7 shows an external view of a lamp 500 including a solid-state light emitting element as a light source according to a fourth modification.

FIG. 8 shows an external view of a lamp 600 including a solid-state light emitting element as a light source according to the fourth modification.

FIG. 9 shows an external view of a lamp 700 including a solid-state light emitting element as a light source according to a fifth modification.

FIG. 10 shows an external view of a lamp 800 including a solid-state light emitting element as a light source according to a sixth modification.

FIG. 11 shows an external view of a lamp 900 including a solid-state light emitting element as a light source according to a seventh modification.

FIG. 12 shows an external view of a lamp 1000 including a solid-state light emitting element as a light source according to an eighth modification.

FIG. 13 shows an external view of a lamp 1100 including a solid-state light emitting element as a light source according to a second embodiment.

FIG. 14 shows an external view of a lamp 1200 including a solid-state light emitting element as a light source according to a ninth modification.

FIG. 15 shows an external view a lamp 1300 including a solid-state light emitting element as a light source according to a tenth modification.

FIG. 16 shows an external view of a lamp 1400 including a solid-state light emitting element as a light source according to a third embodiment.

FIG. 17 shows an external view of a lamp 1500 including a solid-state light emitting element as a light source according to a fourth embodiment.

FIG. 18 shows an external view of an illuminating device 1600 according to a fifth embodiment.

### DESCRIPTION OF EMBODIMENTS

### First Embodiment

<Outline>

A first embodiment is a bulb-shaped lamp including a solid-state light emitting element as a light source, in which a drive circuit is arranged in a hollow space, away from a base and a light emitting module. In the lamp, heat generated by the light emitting module is difficult to be transmitted to the drive circuit, whereby heat burden to the drive circuit is reduced and durability of the drive circuit is improved.

<Configuration>

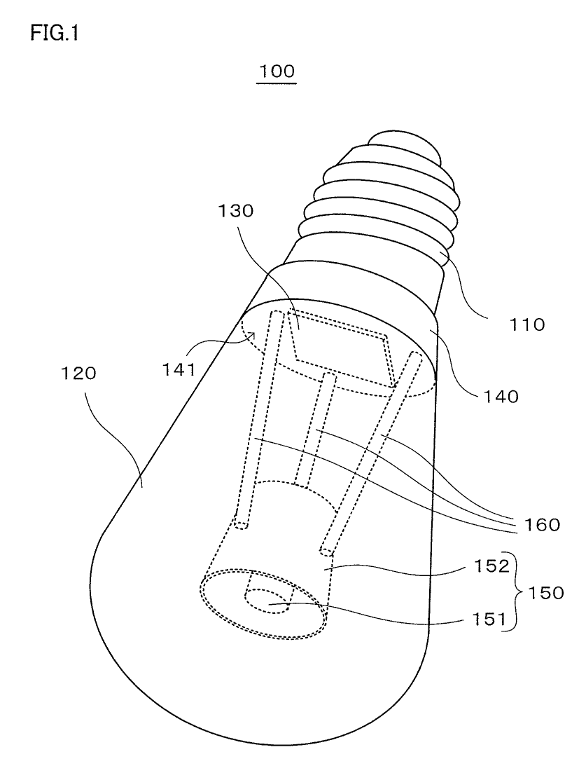

FIG. 1 shows an external view of a lamp 100 including a solid-state light emitting element as a light source according to the first embodiment.

The lamp 100 according to the first embodiment is a lamp including a solid-state light emitting element as a light source, and includes a base 110, a globe 120, a light emitting module 130, a lamp housing 140, a drive circuit section 150, and a supporting member 160, as shown in FIG. 1.

The base 110 is formed of a structural material such as metal and resin, and is a part which is attached to an external apparatus when the lamp is used, connected to a commercial power source, and supplied with power. It should be noted that the shape of the base 110 is not limited in particular. It is sufficient that metal is used in the electrical connection portion to the socket. For example, in the present embodiment, an E-base which is used in an existing bulb is used. Other than this, a BA-base, a pin type G-base, a GU-base, or a GX-base can be used. Further, a base of a new specification may be used.

The lamp housing 140 has a cylindrical shape whose outer diameter decreases from one end to the other end. The lamp housing 140 is closed with a cover on the greater outer diameter side thereof, and an upper face of the cover serves as a light emitting module mounting face 141. The lamp housing 140 has an opening on the smaller outer diameter side thereof, and is closed with the base 110. Electric wires for supplying power from the base 110 to the drive circuit 150, and the like, are housed inside the tubular lamp housing.

The globe 120 is a hollow spherical cover having an opening, and its outer shell is formed by a translucent material such as a resin material or a glass material. Its opening edge is connected with an adhesive member to a ring-shaped groove provided near the outer periphery of the module mounting face of the lamp housing 140. A diffusion film is formed on the inner wall of the globe 120, in order to change the directions of light passing through the globe 120 and light reflected in the interior of the globe 120 to various directions to diffuse them, thereby reducing unevenness in brightness. As a material of the diffusion film, it is possible to use metal oxide fine particles including silicon oxide, aluminum oxide, zinc oxide, yttrium oxide, titanium oxide, zirconium oxide, and barium oxide. Instead of or in combination of the diffusion film, a translucent resin material or a glass material that includes such fine particles may be used for forming the globe 120. Alternatively, fine foam may be used instead of fine particles.

The diameter of the maximum diameter portion of the globe 120 is greater than the diameter of the maximum diameter portion of the lamp housing 140. When viewed from the base 110, the maximum diameter portion of the globe 120 projects relative to the maximum diameter portion of the lamp housing 140. Through a synergistic effect of such an outer shape of the globe and the above diffusion film, it is possible to realize a total light distribution characteristic which allows light to advance also to the base side.

The parts indicated by the dotted lines in FIG. 1 show how components are arranged in the globe 120 when the inner space is viewed through the globe 120. It should be noted that, in the present embodiment, the inner space cannot actually be seen through the globe 120, since the globe 120 is a complete diffusion type globe having 98% transmittance.

The light emitting module 130 is an assembly of solid-state light emitting elements for illumination, which is realized by a unit composed of one or a plurality of solid-state light emitting elements such as LEDs or ELs. The light emitting module 130 is installed substantially at the center of the module mounting face 141 of the lamp housing 140 made of a heat conduction member, and is driven by the drive circuit section 150 which is supplied with power from the base.

Further, the light emitting module 130 may be a unit composed of LEDs or ELs which each emit light of a single color such as red, green, or blue, or may be implemented by combining LEDs or ELs of these various colors as appropriate, so as to emit light of white or any other color. Further, the light emitting module 130 may be implemented by molding, around LEDs, a wavelength conversion member such as a YAG phosphor, silicate phosphor, oxynitride phosphor, rare earth doped glass phosphor, organic phosphor, metal complex phosphor, or the like, so as to emit light of white or any other color. For example, the light emitting module 130 may be implemented by molding, around LEDs that emit blue light, a wavelength conversion member that converts blue light to light of a complementary color to blue, thereby emitting white light.

Further, the light emitting module 130 may be implemented in a form in which a wavelength conversion member is installed on a module substrate on which LED elements have been primary-mounted, or in a form in which a package including LED elements and a phosphor is secondary-mounted on a module substrate.

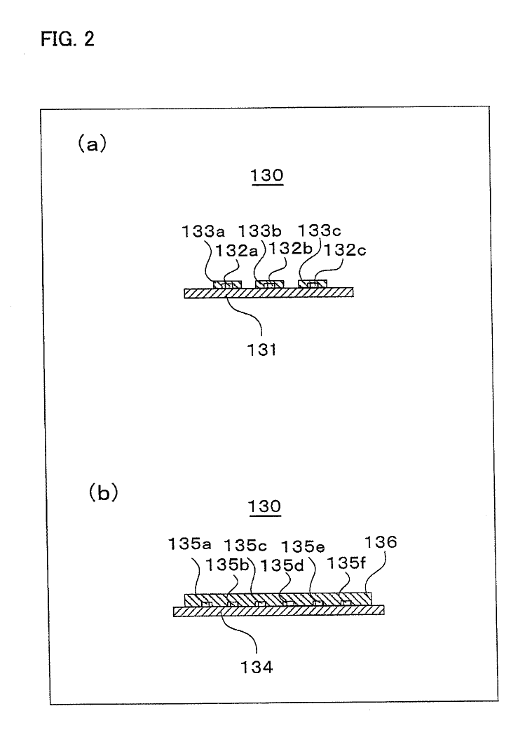

Further, as shown in the cross-sectional view in FIG. 2(a), the light emitting module 130 may be implemented in a form in which a plurality of LED elements 132a to 132c are installed on a module substrate 131 and the LED elements 132a to 132c are sealed with wavelength conversion members 133a to 133c, respectively, which are each made of a silicone resin or the like with a blue excitation phosphor or the like dispersed therein. Alternatively, as shown in the cross-sectional view in FIG. 2(b), the light emitting module 130 may be implemented in a form in which a plurality of LED elements 135a to 135f installed on a module substrate 134 are collectively sealed with a wavelength conversion member 136. In the form where the LED elements are collectively sealed to form a flat surface as shown in FIG. 2(b), diffused light is emitted. Thus, the present invention can attain a more advantageous effect.

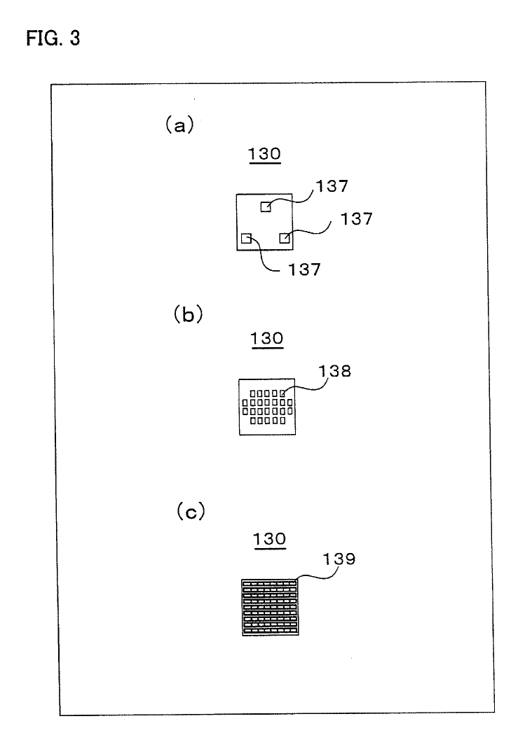

Each of FIGS. 3(a) to 3(c) shows a specific example of how to arrange LED elements in the light emitting module 130.

As shown in FIG. 3(a), for example, three high luminous flux LEDs 137 are arranged on the light emitting module 130, in a triangle shape with an interval of approximately 5 to 15 mm therebetween. Alternatively, as shown in FIG. 3(b), for example, 22 relatively-high luminous flux LEDs 138 are two-dimensionally arranged on the light emitting module 130. Alternatively, as shown in FIG. 3(c), for example, 72 small LEDs 139 are two-dimensionally and densely arranged on the light emitting module 130, in a quadrangle having approximately 10 to 15 mm dimensions.

Here, the sealing agent for the light emitting module 130 may be a fluorine resin, sol-gel glass, or low-melting point glass, as well as a silicone resin, and in order to improve heat conductivity, thixotropy, and light diffusibility (mixing of LED light and phosphor light), it is preferable to add fine particles (nano particles of several to several hundred nm, and micro particles of several to several tens μm) of a translucent metal oxide, nitride, or carbide (silicon oxide, titanium oxide, zinc oxide, zirconium oxide, aluminum oxide, aluminium nitride, silicon nitride, boron nitride, silicon carbide, or the like).

In order to thermally connect the light emitting module 130 and the base 110 and enhance the heat dissipation performance of the light emitting module 130 via the base 110, the components are configured as follows.

In the lamp housing 140, the body is made of a heat conduction material such as a metal material or a resin material having an increased heat conductivity by including metal oxide fine particles, and the face of the lamp housing 140 opposite to the base 110 serves as the module mounting face 141. When the lamp housing 140 is made of a metal material, the base 110 is connected to the lamp housing 140, via an insulating member (not shown) which is provided therebetween and which is made of an insulating material and having a high heat conductivity. Here, as the insulating member, a member having a high heat conductivity, such as ceramics or a high heat conduction resin material, may be used. Further, by filling the base 110 with a silicone resin or the like, it is possible to increase the heat conductivity in the base 110.

Through such configurations, it is possible to actively dissipate heat of the light emitting module 130 via the base 110, as well as via the lamp housing 140. Further, it is possible to downsize the lamp housing 140. As a result, by causing the globe 120 to have a diameter greater than that of the module mounting face 141, and thus a projecting shape, it is possible to cause the lamp to have a shape close to or equivalent to that of an existing bulb. Further, since the heat dissipation performance via the base is improved, even if the light emitting module is supplied with higher power, heat increase in the light emitting module can be suppressed. Thus, it is possible to obtain a higher luminous flux of the lamp. As described above, since the lamp housing 140 may be small, the base 110 and the lamp housing 140 may be integrated to be a base part. Further, the base 110, the lamp housing 140, and the supporting member 160 may be integrated to be a base part.

The drive circuit section 150 is installed in an inner space made by the globe 120 being connected to the lamp housing 140, at a position away from the base 110, the lamp housing 140, and the light emitting module 130, and lights the light emitting module 130 by using power received from the base 110.

In the present embodiment, the drive circuit section 150 is installed in the hollow space between the light emitting module 130 and the globe 120, so as to block some of light emitted from the light emitting module 130 and advancing to the inner face of the globe 120.

Therefore, the base 110, the lamp housing 140, the light emitting module 130, and the drive circuit section 150 are arranged in this order.

In the present embodiment, the shape in a planar view of the drive circuit section 150 viewed from the light emitting module 130 is circular. In addition, the drive circuit section 150 is arranged on the axis passing through the base 110 of the lamp and the tip of the globe 120. Through this configuration, it is possible to obtain a light distribution characteristic of a good symmetry.

The drive circuit section 150 includes an electronic circuit 151 which outputs power appropriate for lighting the light emitting module 130, and a circuit cover 152 formed by a reflective material, installed around the electronic circuit 151.

Here, the circuit cover 152 holds the electronic circuit, and preferably, is made of a substance that endures heat generated by the electronic circuit and has a relatively high reflectance. In particular, desirable is a substance that causes little temporal decrease of reflectance and has a reflectance of 80% or more in the wavelength range of visible light emitted from the light emitting module. As an example of a high reflectance material, it is possible to use a material containing a high reflectance metal such as aluminum, silver, or platinum, or metal oxide fine particles including silicon oxide, aluminum oxide, zinc oxide, yttrium oxide, titanium oxide, zirconium oxide, and barium oxide. When metal oxide fine particles whose particle diameters are 1 μm to 30 μm are used, a light diffusion effect is exhibited, and thus, it is possible to attain a more uniform light distribution characteristic. Further, a resin or glass containing metal oxide fine particles may be used. Alternatively, a multilayer reflecting film including such metal oxides may be used.

The supporting member 160 supports and fixes the drive circuit section 150. In the present embodiment, the supporting member 160 is implemented by three stick-like supports attached to the lamp housing 140. One ends of the supports of the supporting member 160 are arranged on the light emitting module mounting face 141, around the light emitting module 130, and the other ends thereof are arranged on the drive circuit section 150 at equal intervals. Here, the number of the supports is not limited, but too large a number is not desirable because optical paths are greatly blocked by the supporting member. Further, by the drive circuit section 150 being supported by the three supports, even if thin supports are used as the supporting member in order to suppress light from being blocked by the supporting member, it is possible to prevent the drive circuit section 150 from being displaced when the lamp is inclined. The supporting member 160 can also be used as a wire for supplying power to the drive circuit section 150. Similarly, the supporting member 160 can also be used as a wire for supplying power from the drive circuit section 150 to the light emitting module 130.

As the supporting member 160, it is possible to use a translucent member such as glass or resin, or a reflecting member such as metal or ceramics.

Circuit elements may be mounted on both sides of the substrate. Since the necessary substrate area can be reduced, the drive circuit section can be downsized. In particular, if thick circuit elements are arranged at the centers of both sides of the substrate, the drive circuit section can be formed in a longitudinally elongated shape. Accordingly, it is possible to reduce the area in which light advancing from the light emitting module toward the tip of the globe is blocked by the drive circuit section. That is, it is possible to suppress decrease in the brightness at the tip of the globe.

It should be noted that wires (not shown) between the electronic circuit 151 and the light emitting module 130, and between the electronic circuit 151 and the base 110 may be provided along the supporting member 160.

In the present embodiment, since there is no drive circuit between the light emitting module and the base, it is possible to directly and thermally connect the light emitting module to the base, and thus, it is possible to greatly improve the heat dissipation characteristic. Moreover, since it is easy to provide the light emitting module near the base, it is possible to cause the globe to greatly project from near the base, and to have an outer shape close to or equivalent to that of an existing bulb. This causes no problem that the size or the shape of the lamp is different from those of an existing bulb and thus the lamp cannot be attached to an existing apparatus. Further, since it is possible to obtain a total light distribution characteristic similar to that in an existing bulb, it is possible to obtain a similar light distribution even when the lamp is attached to an existing apparatus. As a result, applicability of the lamp to existing apparatuses is greatly improved.

Generally, the life of a lamp is determined according to the lives of LED elements and circuit elements. There also are cases where the life of a lamp is regulated by the lives of circuit elements, when lives of LED elements are prolonged. If some circuit elements such as heat-sensitive parts, e.g., an electric field capacitor, are arranged in the base, and heat increase during operation can be suppressed, even if an inexpensive electric field capacitor is used, it is possible to realize a prolonged life of a lamp.

[First Modification]

A lamp according to a first modification has features similar to those of the first embodiment, in which lamp the supporting member is implemented by one support.

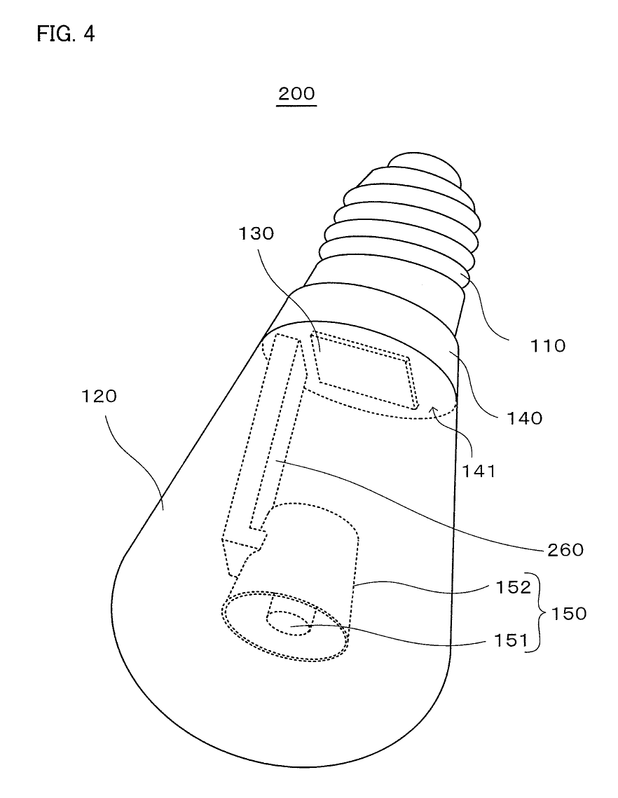

FIG. 4 shows an external view of a lamp 200 including a solid-state light emitting element as a light source according to the first modification. Here, components similar to those of the lamp 100 of the first embodiment are denoted by the same reference numerals, and description thereof will be omitted.

The lamp 200 according to the first modification has a configuration in which the supporting member 160 of the lamp 100 according to the first embodiment is replaced with a supporting member 260.

The supporting member 260 is one support attached to the base 110. The first modification uses a thicker and more rigid support or a support having a structurally-stronger shape, such as H steel or prism, than one of the plurality of supports as in the first embodiment.

It should be noted that wires (not shown) between the electronic circuit 151 and the light emitting module 130, and between the electronic circuit 151 and the base 110 may be provided along the supporting member 260. Alternatively, a cavity is created inside the supporting member 260 and such wires may be provided so as to pass through the cavity.

[Second Modification]

A lamp according to a second modification has features similar to those of the first embodiment, in which lamp the supporting member is implemented by a tube made of translucent glass or resin.

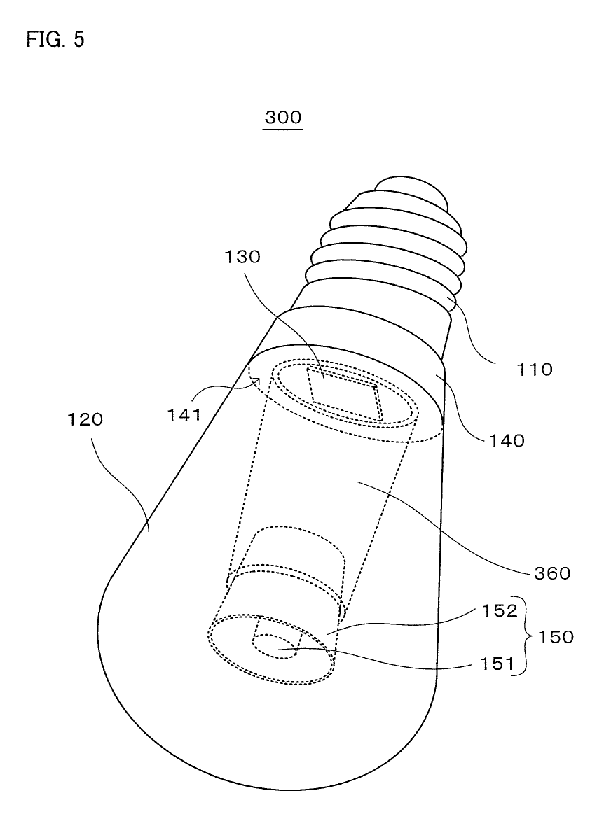

FIG. 5 shows an external view of a lamp 300 including a solid-state light emitting element as a light source according to the second modification. Here, components similar to those of the lamp 100 of the first embodiment are denoted by the same reference numerals, and description thereof will be omitted.

The lamp 300 according to the second modification has a configuration in which the supporting member 160 of the lamp 100 according to the first embodiment is replaced with a supporting member 360.

The supporting member 360 is one translucent tube attached to the base 110, and is installed so as to surround the light emitting module 130. In the second modification, the internal diameter of the tube on the drive circuit section 150 side is approximately the same of a part of the outer diameters of the drive circuit section 150, thereby enabling the supporting member 360 to easily support the drive circuit section 150.

Transparent wires (not shown) may be provided on a surface of the supporting member 360, so as to be used for connection between the electronic circuit 151 and the light emitting module 130, and between the electronic circuit 151 and the base 110.

It should be noted that, the supporting member 360 may have an optical function, for example, on the side wall thereof, to emit light in a predetermined direction.

[Third Modification]

A lamp according to a third modification has features similar to those of the first embodiment, in which lamp the supporting member is implemented by a prop provided on the inner wall of the globe.

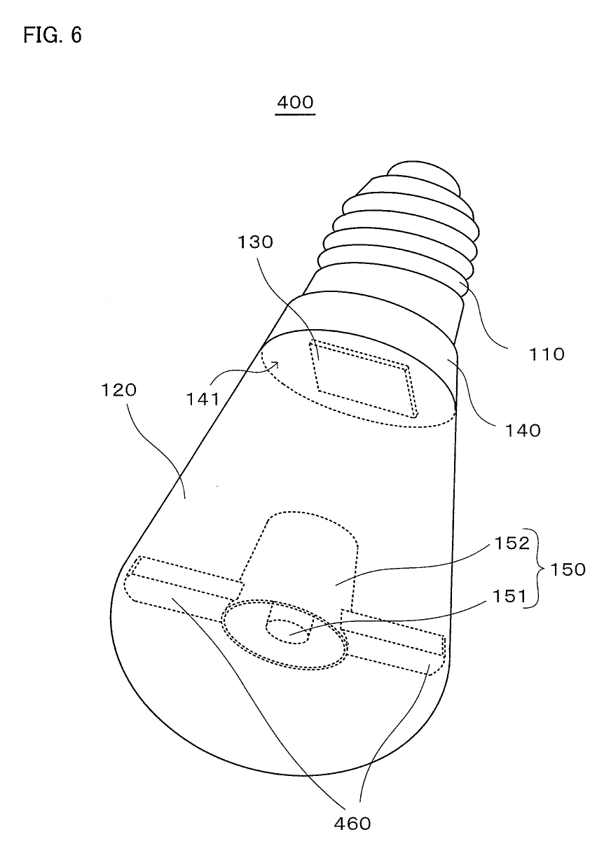

FIG. 6 shows an external view of a lamp 400 including a solid-state light emitting element as a light source according to the third modification. Here, components similar to those of the lamp 100 of the first embodiment are denoted by the same reference numerals, and description thereof will be omitted.

The lamp 400 according to the third modification has a configuration in which the supporting member 160 of the lamp 100 according to the first embodiment is replaced with a supporting member 460.

The supporting member 460 is, for example, an elastic support, and supports the drive circuit section 150 by propping, like a tension bar, against opposing portions of the inner wall of the globe.

Transparent wires (not shown) may be provided on the inner face of the globe 120, so as to be used for connection between the electronic circuit 151 and the light emitting module 130, and between the electronic circuit 151 and the base 110.

[Fourth Modification]

A lamp according to a fourth modification has features similar to those of the first embodiment, in which lamp the supporting member is formed of a translucent resin material and the drive circuit section 150 is bonded to the inner wall of the globe.

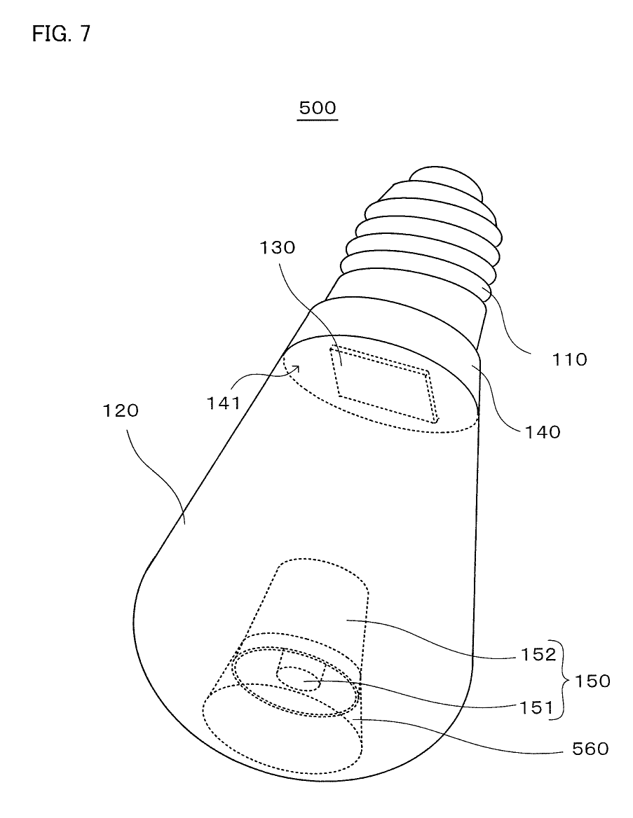

FIG. 7 shows an external view of a lamp 500 including a solid-state light emitting element as a light source according to the fourth modification. Here, components similar to those of the lamp 100 of the first embodiment are denoted by the same reference numerals, and description thereof will be omitted.

The lamp 500 according to the fourth modification has a configuration in which the supporting member 160 of the lamp 100 according to the first embodiment is replaced with a supporting member 560.

The supporting member 560 is formed of a translucent resin material bonded to the inner wall of the globe 120. The supporting member 560 may be bonded with a transparent adhesive or may be a transparent adhesive itself.

It is desirable that transparent electrodes (not shown) are used for connection between the electronic circuit 151 and the light emitting module 130, and between the electronic circuit 151 and the base 110.

In the lamp 500, the drive circuit section 150 is arranged at a tip position, which is farthest from the base 110, on the inner wall of the globe 120. However, if the supporting member 560 is used, since the drive circuit section 150 can be bonded at any position on the inner wall of the globe 120, it is possible to change arrangement of the drive circuit section 150 as appropriate, in accordance with its use.

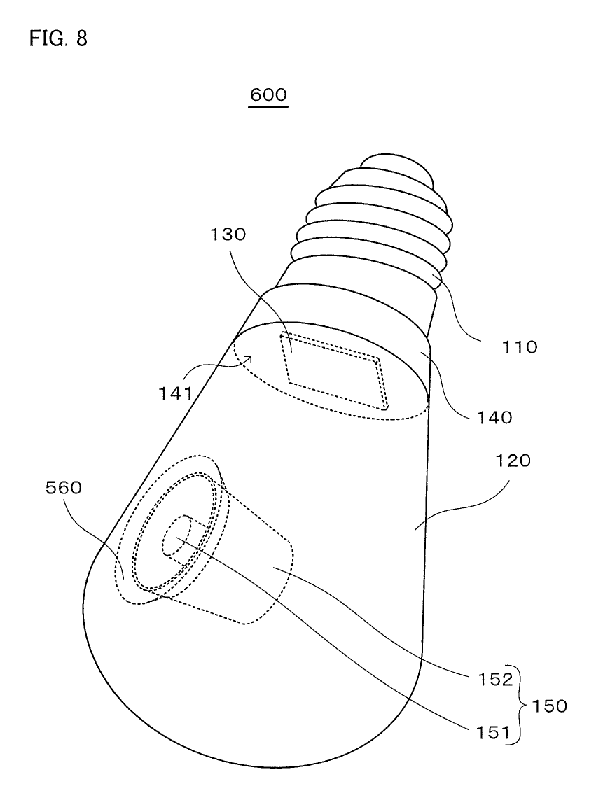

FIG. 8 shows an external view of a lamp 600 including a solid-state light emitting element as a light source according to the fourth modification. Here, components similar to those of the lamp 500 of the present embodiment are denoted by the same reference numerals, and description thereof will be omitted.

The lamp 600 according to the fourth modification is different from the lamp 500, only in the position at which the drive circuit section 150 is arranged. The drive circuit section 150 is arranged on the inner wall of the globe 120 at a middle position, i.e., at a position where the distance between the drive circuit section 150 and the base 110 is about a half of the distance between the base 110 and the tip position.

[Fifth Modification]

A lamp according to a fifth modification has features similar to those of the first embodiment, in which lamp a hole is further formed in the substrate of the electronic circuit so as to allow light to pass therethrough.

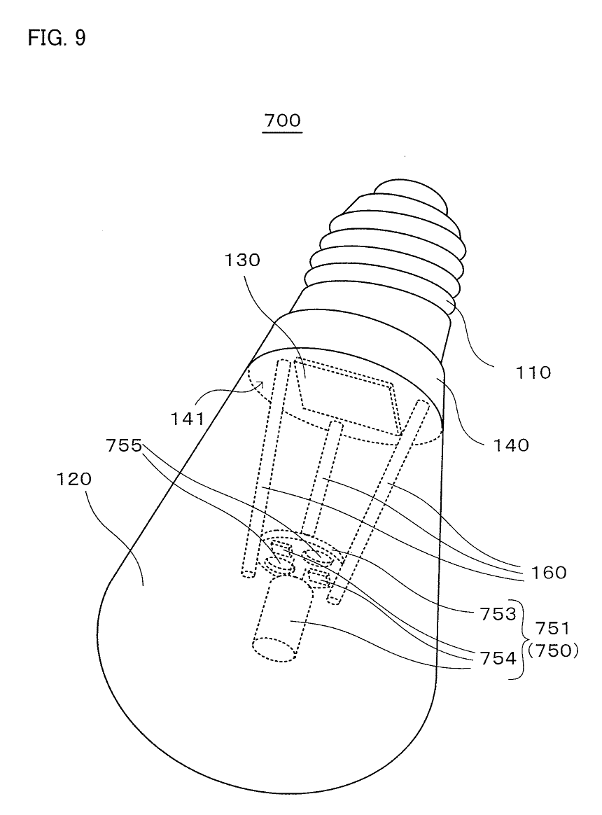

FIG. 9 shows an external view of a lamp 700 including a solid-state light emitting element as a light source according to the fifth modification. Here components similar to those of the lamp 100 of the first embodiment are denoted by the same reference numerals, and description thereof will be omitted.

The lamp 700 according to the fifth modification has a configuration in which the drive circuit section 150 of the lamp 100 according to the first embodiment is replaced with a drive circuit section 750.

The drive circuit section 750 has a configuration in which the electronic circuit 151 of the drive circuit section 150 is replaced with an electronic circuit 751 and the circuit cover 152 is eliminated. Since the circuit cover 152 is eliminated, the electronic circuit 751 and the drive circuit section 750 have the same configuration.

The electronic circuit 751 includes a substrate 753, and a circuit element 754 mounted on the substrate 753.

Holes 755 for allowing light to pass therethrough are formed in the substrate 753.

In order to obtain a light distribution characteristic of a good symmetry, it is preferable that a capacitor being a thick circuit component is arranged at the center of the substrate.

Here, a plurality of small holes or one large hole may be formed in the substrate 753. For example, when one large round hole is formed in a center portion of a round substrate, the substrate has a doughnut shape.

In the fifth modification, since light passes through the holes formed in the substrate 753, even if the circuit cover 152 is eliminated, it is possible to alleviate decrease of the luminous flux of the lamp due to the drive circuit. Moreover, the circuit cover 152 may be used. In that case, in order to block as little as possible light passing through the holes formed in the substrate 753, it is necessary to form holes at appropriate positions in the circuit cover 152.

[Sixth Modification]

A lamp according to a sixth modification has features similar to those of the first embodiment, in which lamp, further, the base material of the substrate of the electronic circuit is a translucent material such that the substrate allows light to easily pass therethrough. It should be noted that the substrate may have a light reflection characteristic and a light diffusibility.

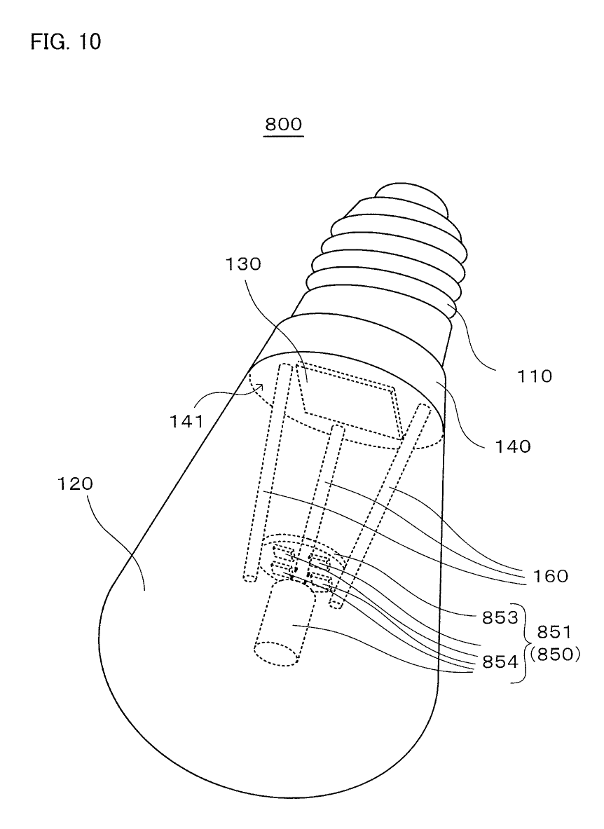

FIG. 10 shows an external view of a lamp 800 including a solid-state light emitting element as a light source according to the sixth modification. Here, components similar to those of the lamp 100 of the first embodiment are denoted by the same reference numerals, and description thereof will be omitted.

The lamp 800 according to the sixth modification has a configuration in which the drive circuit section 150 of the lamp 100 according to the first embodiment is replaced with a drive circuit section 850.

The drive circuit section 850 has a configuration in which the electronic circuit 151 of the drive circuit section 150 is replaced with an electronic circuit 851 and the circuit cover 152 is eliminated. Since the circuit cover 152 is eliminated, the electronic circuit 851 and the drive circuit section 850 have the same configuration.

The electronic circuit 851 includes a substrate 853 and a circuit element 854 mounted on the substrate 853.

The base material of the substrate 853 is a translucent resin or glass material, and the substrate 853 allows light to pass therethrough to some extent.

In the sixth modification, since the substrate 853 allows light to pass therethrough, it is possible to alleviate decrease of the luminous flux of the lamp due to the drive circuit.

[Seventh Modification]

A lamp according to a seventh modification has features similar to those of the first embodiment, in which lamp the substrate of the electronic circuit is longitudinally arranged so as to increase the amount of light passing therethrough.

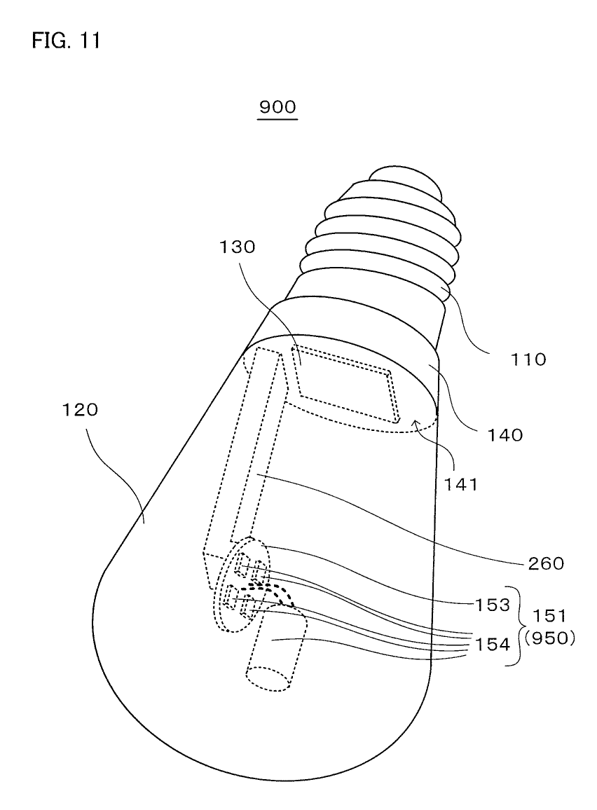

FIG. 11 shows an external view of a lamp 900 including a solid-state light emitting element as a light source according to the seventh modification. Here, components similar to those of the lamp 200 of the first modification are denoted by the same reference numerals, and description thereof will be omitted.

The lamp 900 according to the seventh modification has a configuration in which the drive circuit section 150 of the lamp 200 according to the first modification is replaced with a drive circuit section 950.

The drive circuit section 950 has a configuration in which the installation direction of the electronic circuit 151 of the drive circuit section 150 is changed and the circuit cover 152 is eliminated. Since the circuit cover 152 is eliminated, the electronic circuit 151 and the drive circuit section 950 have the same configuration.

The electronic circuit 151 includes a substrate 153 and a circuit element 154 mounted on the substrate 153.

As shown in FIG. 11, the substrate 153 is installed such that the mounting face thereof is substantially parallel to the emission direction of the light emitting module 130.

In the seventh modification, the substrate 153 is installed such that light emitted from the light emitting module 130 is blocked as little as possible. Although the substrate 153 does not block the emitted light, the circuit element 154 now blocks light emitted by the light emitting module 130.

However, since the circuit element 154 is a collection of a plurality of small parts, there are gaps between the parts. Therefore, a considerable amount of light can pass through these gaps. Moreover, each part may be installed in a direction that would not block emitted light as much as possible.

Therefore, by changing the installation direction of the substrate 153 in the manners as described above, it is possible, as a whole, to alleviate decrease of the luminous flux of the lamp due to the drive circuit. In the seventh modification, the circuit cover 152 is basically unnecessary. However, reflective materials may be locally arranged so as to cover a surface of the substrate 153.

[Eighth Modification]

A lamp according to an eighth modification has features similar to those of the first embodiment, in which lamp a second light emitting module is further provided to the globe side shaded by the drive circuit, in addition to the light emitting module installed on the side nearer to the base.

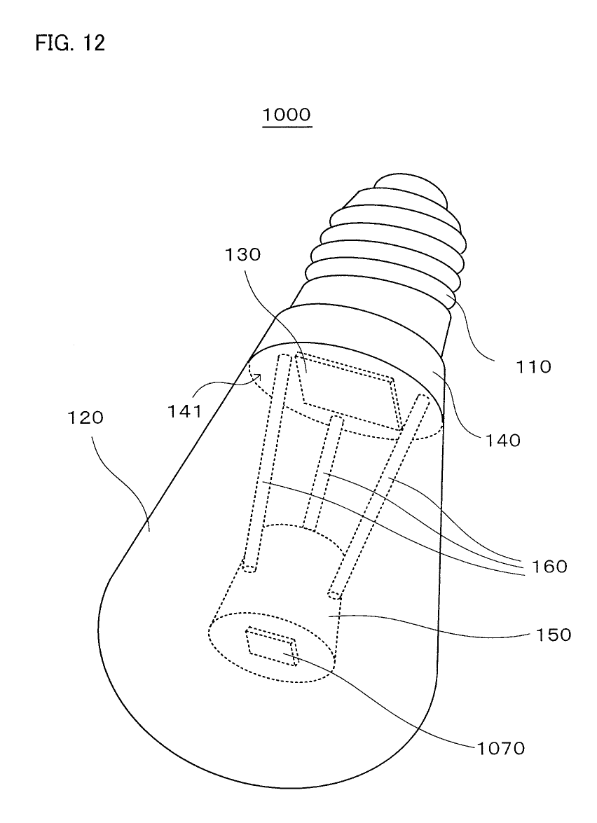

FIG. 12 shows an external view of a lamp 1000 including a solid-state light emitting element as a light source according to the eighth modification. Here, components similar to those of the lamp 100 of the first embodiment are denoted by the same reference numerals, and description thereof will be omitted.

The lamp 1000 according to the eighth modification is the lamp 100 according to the first embodiment to which a second light emitting module 1070 is further added. The other configurations are the same as those of the lamp 100.

The second light emitting module 1070 is arranged to the globe side shaded by the drive circuit section 150, and separately emits light to a portion where light from the first light emitting module 130 is blocked by the drive circuit section 150. Here, the second light emitting module 1070 compensates light from the first light emitting module 130, and thus, a light emitting module having a luminous flux lower than that of the first light emitting module 130 may be used. Accordingly, heat generated from the second light emitting module 1070 is little, and thus, a heat dissipation mechanism may not be provided in particular.

In the eighth modification, the second light emitting module 1070 compensates a decreased amount of the luminous flux of the lamp. Therefore, even without the circuit cover 152, it is possible to cancel decrease of the luminous flux of the lamp due to the drive circuit. Further, when the circuit cover 152 is used, improvement of light emission efficiency can be expected.

### Second Embodiment

<Outline>

A second embodiment is a lamp in which a drive circuit is arranged in a hollow space as in the first embodiment, to a light emitting side of three-dimensionally arranged light emitting modules, and which has features similar to those of the first embodiment.

<Configuration>

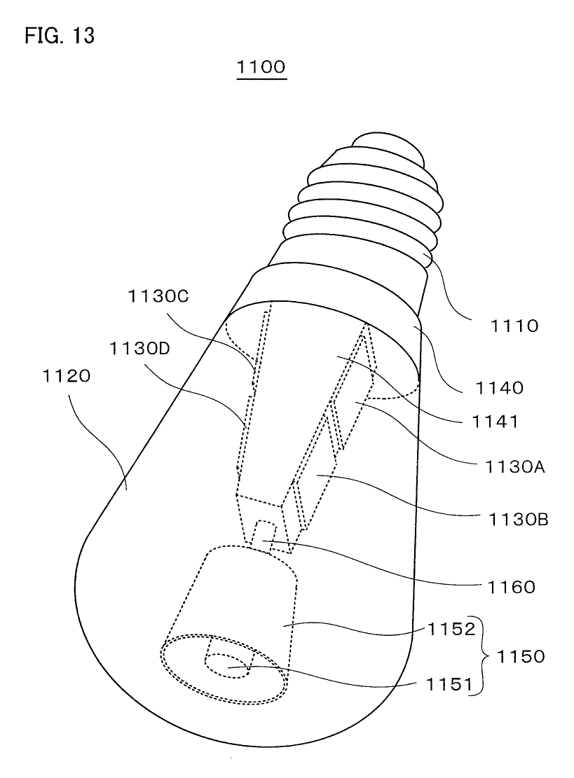

FIG. 13 shows an external view of a lamp 1100 including a solid-state light emitting element as a light source according to the second embodiment.

The lamp 1100 according to the second embodiment is a lamp including a solid-state light emitting element as a light source, and includes a base 1110, a globe 1120, light emitting modules 1130A to D, a lamp housing 1140, a drive circuit section 1150, and a supporting member 1160, as shown in FIG. 13.

Similarly to the base 110 of the first embodiment, the base 1110 is formed of a structural material such as metal or resin, and is a part which is attached to an external apparatus when the lamp is used, connected to a commercial power source, and supplied with power.

Similarly to the globe 120 of the first embodiment, the globe 1120 is a cover made of translucent resin or glass, on which a diffusion film is formed that changes the directions of light passing through the globe 1120 and light reflected in the interior of the globe 1120 to various directions to diffuse them, thereby reducing unevenness in brightness. The globe 1120 is connected to the lamp housing 1140 to form an inner space. The globe 1120 is a component not necessarily required.

Similarly to the light emitting module 130 of the first embodiment, each of the light emitting modules 1130A to D is an assembly of solid-state light emitting elements for illumination, which is realized by a unit composed of one or a plurality of solid-state light emitting elements such as LEDs or ELs. The light emitting modules 1130A to D are installed on a module installation base 1141 projecting from the lamp housing 1140 made of a heat conduction member, such that the light emitting modules 1130A to D do not overlap each other. The light emitting modules 1130A to D are driven by the drive circuit section 1150 which is supplied with power from the base.

Here, detailed features of each of the light emitting modules 1130A to D are the same as those of the light emitting module 130.

Similarly to the lamp housing 140 of the first embodiment, in the lamp housing 1140, the body is made of a metal material or a resin material having an increased heat conductivity by including metal oxide fine particles, and the module installation base 1141 projects from the face of the lamp housing 1140 opposite to the base 110.

Similarly to the drive circuit section 150 of the first embodiment, the drive circuit section 1150 is installed in an inner space made by the globe 1120 being connected to the lamp housing 1140, at a position away from the base 1110, the lamp housing 1140, and the light emitting modules 1130A to D, and lights the light emitting modules 1130A to D by using power received from the base 1110.

In the present embodiment, the drive circuit section 1150 is installed in the hollow space between the light emitting modules 1130A to D and the globe 1120.

Accordingly, the base 1110, the lamp housing 1140, the light emitting modules 1130A to D, and the drive circuit section 1150 are arranged in this order.

Further, the drive circuit section 1150 includes an electronic circuit 1151 which outputs power appropriate for lighting the light emitting modules 1130A to D, and a circuit cover 1152 installed on a surface of the electronic circuit 1151.

Here, the circuit cover 1152 is similar to the circuit cover 152 of the first embodiment.

Further, the supporting member 1160 is similar to the supporting member 160 of the first embodiment.

[Ninth Modification]

A lamp according to a ninth modification has features similar to those of the second embodiment, in which lamp some of light emitted by a light emitting module is guided to a globe side shaded by the drive circuit, by further using a light guide plate.

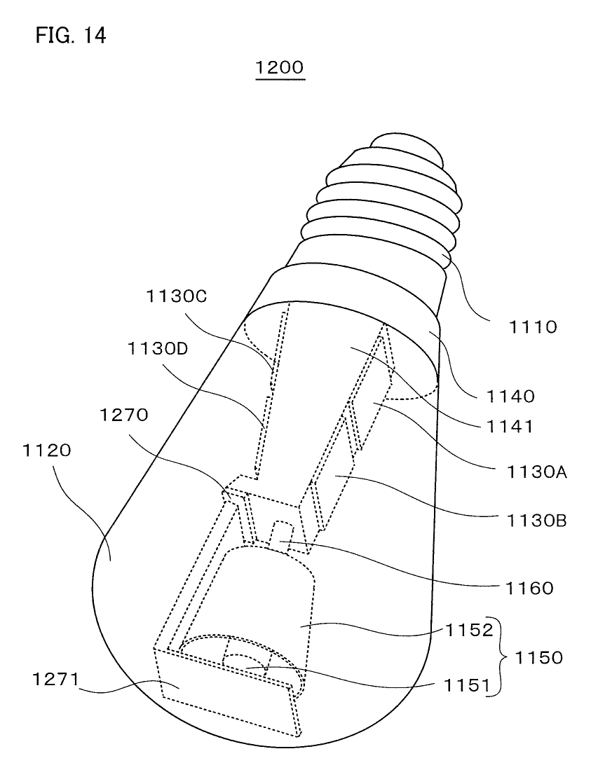

FIG. 14 shows an external view of a lamp 1200 including a solid-state light emitting element as a light source according to the ninth modification. Here, components similar to those of the lamp 1100 of the second embodiment are denoted by the same reference numerals, and description thereof will be omitted.

The lamp 1200 according to the ninth modification is the lamp 1100 according to the second embodiment to which a light emitting module 1270 and a light guide plate 1271 are further added, and in which the shape of the module installation base 1141 is partially changed to provide an installation place for the light emitting module 1270. The other configurations are the same as those of the lamp 1100.

Similarly to the light emitting modules 1130A to D, the light emitting module 1270 is an assembly of solid-state light emitting elements for illumination, and emits light mainly to be introduced to an end face of the light guide plate 1271.

The light guide plate 1271 is a plate for evenly surface-emitting light introduced from an end face thereof, the plate being prepared by, for example, applying special processing to a surface of an acrylic plate or printing reflecting dots on the surface by using white ink. The light guide plate 1271 guides some of light emitted mainly by the light emitting module 1270 to the globe side shaded by the drive circuit section 1150, so as to surface-emit the light, thereby illuminating a portion where light from the light emitting modules 1130A to D is blocked by the drive circuit section 1150.

In the ninth modification, since the light guide plate 1271 guides some of light emitted in the inner space to the globe side shaded by the drive circuit section 1150, it is possible to alleviate decrease of the luminous flux of the lamp due to the drive circuit.

[Tenth Modification]

A lamp according to a tenth modification has features similar to those of the second embodiment, in which lamp the globe further has a light guiding function that guides some of light emitted by a light emitting module to a globe side shaded by the drive circuit section.

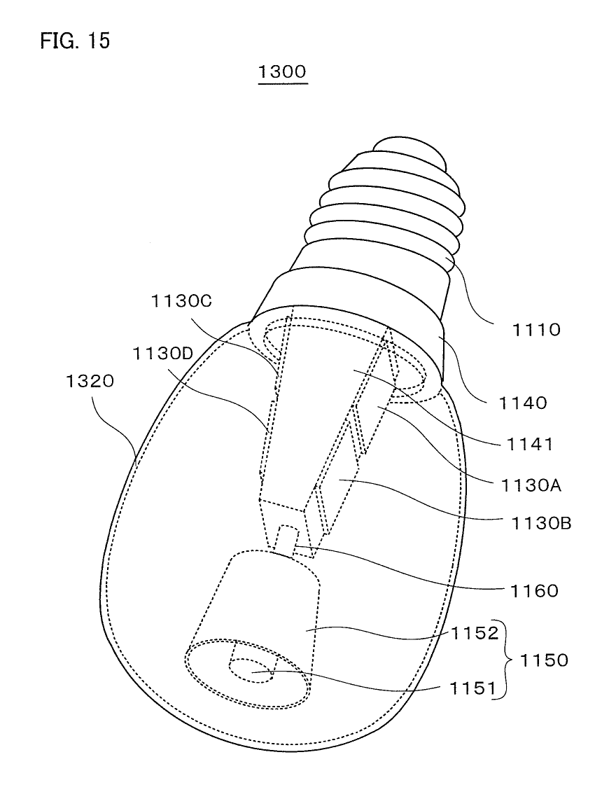

FIG. 15 shows an external view of a lamp 1300 including a solid-state light emitting element as a light source according to the tenth modification. Here, components similar to those of the lamp 1100 of the second embodiment are denoted by the same reference numerals, and description thereof will be omitted.

The lamp 1300 according to the tenth modification has a configuration in which the globe 1120 of the lamp 1100 according to the second embodiment is replaced with a globe 1320.

Similarly to the globe 1120 of the second embodiment, the globe 1320 is a cover made of translucent resin or glass, on which a diffusion film is formed that changes the directions of light passing through the globe 1320 and light reflected in the interior of the globe 1320 to various directions to diffuse them, thereby reducing unevenness in brightness. The globe 1320 is connected to the lamp housing 1140 to form an inner space, and further has a light guiding function that guides some of light emitted mainly by the light emitting module 1130A and the light emitting module 1130C to a portion where light is blocked by the drive circuit section 1150.

It should be noted that the parts indicated by the dotted lines in FIG. 15 show how components are arranged in the housing when the inner space in the housing is viewed through the globe 1320, and the shape of the globe 1320 viewed therethrough.

In the tenth modification, the globe 1320 has a function of guiding some of light emitted in the inner space to a portion where light is blocked by the drive circuit section 1150. Therefore, it is possible to alleviate decrease of the luminous flux of the lamp due to the drive circuit.

### Third Embodiment

<Outline>

A third embodiment is an HID (High Intensity Discharge lamp) type lamp including a solid-state light emitting element as a light source, in which a drive circuit is arranged in a hollow space, away from a base and a light emitting module. The lamp is configured such that heat generated by the light emitting module is difficult to be transmitted to the drive circuit, whereby heat burden to the drive circuit is reduced and durability of the drive circuit is improved.

<Configuration>

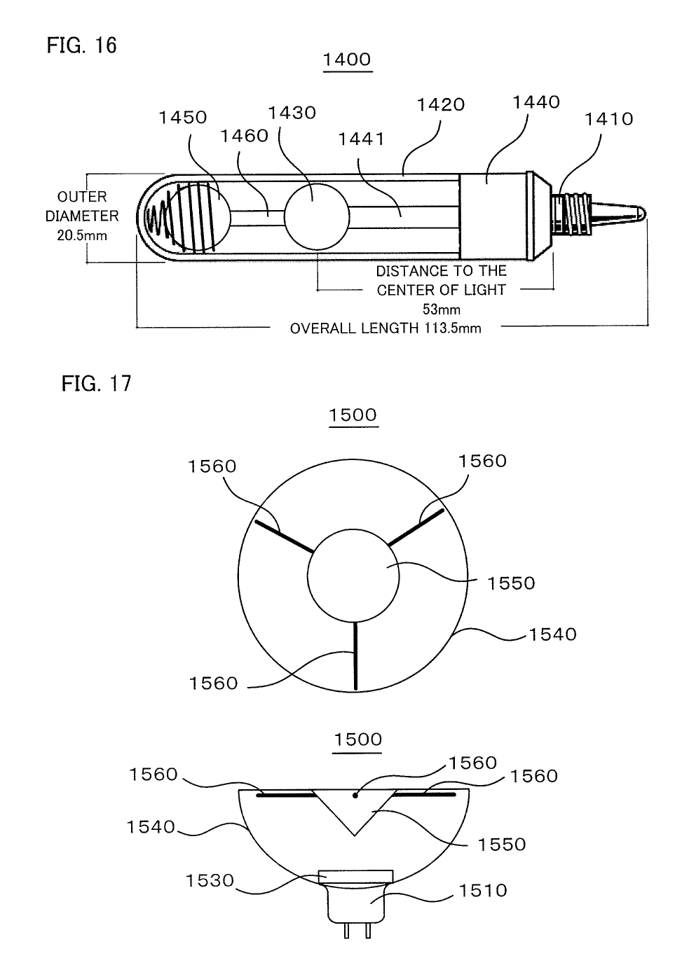

FIG. 16 shows an external view of a lamp 1400 including a solid-state light emitting element as a light source according to the third embodiment.

The lamp 1400 according to the third embodiment is a lamp including a solid-state light emitting element as a light source, and includes a base 1410, an outer tube 1420, a light emitting module 1430, a lamp housing 1440, a drive circuit section 1450, and a supporting member 1460 as shown in FIG. 16.

The base 1410 is an EU10 base, and is functionally similar to the base 110 of the first embodiment although the shape is different.

The outer tube 1420 is a glass tube for protecting the light emitting module 1430, the drive circuit section 1450, and the like. Unlike the globe 120, a diffusion effect is not necessary in particular in the present embodiment, and the outer tube 1420 may be transparent. It should be noted that when a diffusion effect on the globe is not necessary, or when supporting of a light emitting module and safety against an electric shock can be ensured, the globe 120 may not be used.

The light emitting module 1430 is functionally similar to the light emitting module 130 of the first embodiment although the shape is different.

Similarly to the lamp housing 140 of the first embodiment, in the lamp housing 1440, the body is made of a metal material or a resin material having an increased heat conductivity by including metal oxide fine particles, and a module installation base 1441 projects from the face of the lamp housing 1440 opposite to the base 1410.

Similarly to the drive circuit section 150 of the first embodiment, the drive circuit section 1450 is installed in an inner space made by the outer tube 1420 being connected to the lamp housing 1440, at a position away from the base 1410, the lamp housing 1440, and the light emitting module 1430, and lights the light emitting module 1430 by using power received from the base 1410.

The supporting member 1460 supports and fixes the drive circuit section 1450. In the present embodiment, the supporting member 1460 is implemented by one stick-like support attached to the light emitting module 1430. As the supporting member 1460 and the module installation base 1441, it is possible to use a translucent member such as glass or resin, a reflecting member such as metal or ceramics, or a heat conduction member.

Further, wires (not shown) between the drive circuit section 1450 and the light emitting module 1430, and between the drive circuit section 1450 and the base 1410 may be provided along the supporting member 1460 and the module installation base 1441. Alternatively, cavities are created inside the supporting member 1460 and the module installation base 1441, respectively, and such wires may be provided so as to pass through the cavities.

### Fourth Embodiment

A fourth embodiment is a reflector-type lamp including a solid-state light emitting element as a light source provided with a reflecting mirror, in which a drive circuit is arranged in a hollow space, away from a base and a light emitting module. The lamp is configured such that heat generated by the light emitting module is difficult to be transmitted to the drive circuit, whereby heat burden to the drive circuit is reduced and durability of the drive circuit is improved.

<Configuration>

FIG. 17 shows an external view of a lamp 1500 including a solid-state light emitting element as a light source according to a fourth embodiment.

The lamp 1500 according to the fourth embodiment is a lamp including a solid-state light emitting element as a light source, and includes a base 1510, a light emitting module 1530, a lamp housing 1540, a drive circuit section 1550, and a supporting member 1560 as shown in FIG. 17.

The base 1510 is functionally similar to the base 110 of the first embodiment although the shape is different.

The light emitting module 1530 is functionally similar to the light emitting module 130 of the first embodiment although the shape is different.

Similarly to the lamp housing 140 of the first embodiment, in the lamp housing 1540, the body is made of a metal material or a resin material having an increased heat conductivity by including metal oxide fine particles. In the present embodiment, the lamp housing 1540 also has functions as a reflecting mirror and a heat dissipation fin.

Similarly to the drive circuit section 150 of the first embodiment, the drive circuit section 1550 is installed in an inner space surrounded by the lamp housing 1540, at a position away from the base 1510, the lamp housing 1540, and the light emitting module 1530, and lights the light emitting module 1530 by using power received from the base 1510.

Similarly to the supporting member 160 of the first embodiment, the supporting member 1560 supports and fixes the drive circuit section 1550. In the present embodiment, the supporting member 1560 is implemented by three stick-like supports attached to the lamp housing 1540.

Further, wires (not shown) between the drive circuit section 1550 and the light emitting module 1530, and between the drive circuit section 1550 and the base 1510 may be provided along the supporting member 1560. Alternatively, a cavity is created inside the supporting member 1560 and such wires may be provided so as to pass through the cavity.

### Fifth Embodiment

<Outline>

A fifth embodiment is an illuminating device to which the lamp 100 of the first embodiment is attached.

<Configuration>

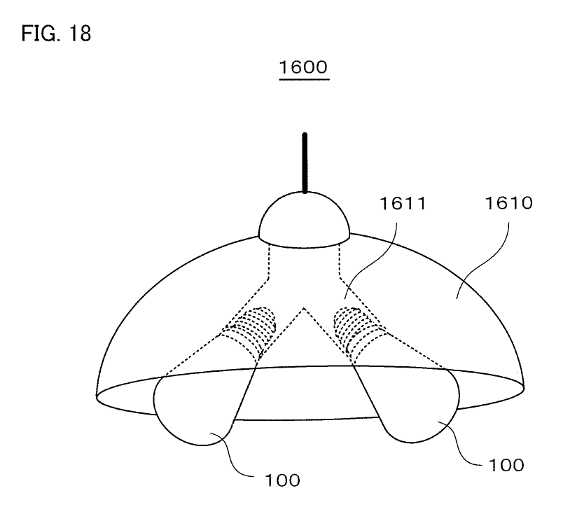

FIG. 18 shows an external view of an illuminating device 1600 according to the fifth embodiment.

The illuminating device 1600 according to the fifth embodiment includes the lamps 100 of the first embodiment and an electric apparatus 1610 which supplies power from a commercial power source to the lamps 100.

The electric apparatus 1410 includes a socket 1611 to which the base 110 of each lamp 100 is connected.

Here, in the illuminating device 1600, each lamp 100 is used in an inclined state.

A conventional lamp including a solid-state light emitting element as a light source has a drive circuit between a light emitting module and a base. Therefore, a globe cannot be formed from near the base, and the ambient illuminance tends to drop extremely.

However, the lamp 100 according to the third embodiment does not have a drive circuit between the light emitting module and the base, and the globe 120 greatly projects from near the base 110. Accordingly, the light distribution characteristic is close to that of a bulb. Therefore, even when the lamp 100 is used in an inclined state as in the illuminating device 1600 or a horizontal state, illuminance does not drop extremely, unlike when a conventional lamp including a solid-state light emitting element as a light source is used in a similar manner.

It should be noted that, the first to fifth embodiments and the first to tenth modifications may be combined together as appropriate, as long as no incompatibility is caused.

<Summary>

As described above, according to the lamps and the electric apparatus of the first to fifth embodiments and the first to tenth modifications, by installing a drive circuit at a position away from the base and the light emitting module, heat generated by the light emitting module is difficult to be transmitted to the drive circuit. Accordingly, heat burden to the drive circuit is made reduced, and thus, improvement of durability of the drive circuit can be expected. Further, there is no drive circuit between the light emitting module and the base, it is structurally easy to enhance the heat dissipation performance of the light emitting module. Further, since it is easy to provide the light emitting module near the base, it is possible to form a globe from near the base, and thus, it is possible to realize an ambient light distribution characteristic close to that of a bulb.

Further, it is possible to install the drive circuit so as not to cause unevenness in illuminance on the emission surface.

Further, it is possible to make inconspicuous a dark portion on the globe due to influence of the drive circuit.

The lamp of the present invention can realize an outer shape as well as a light distribution characteristic similar to those of an existing lamp using a filament or discharge, such as a bulb, a compact fluorescent lamp, a lamp with a reflecting minor, and HID. As a result, it is possible to directly attach the lamp of the present invention to an existing illuminating apparatus, and to obtain a light distribution of the apparatus, equivalent to that when an existing lamp is attached to the existing illuminating apparatus. In addition to that, a prolonged life and a high efficiency can be realized, and thus, its industrial value is extremely high.

### DESCRIPTION OF THE REFERENCE CHARACTERS

100 lamp
110 base
120 globe
130 light emitting module
131 module substrate
132a to 132c LED element
133a to 133c wavelength conversion member
134 module substrate
135a to 135f LED element
136 wavelength conversion member
137, 138, 139 LED
140 lamp housing
150 drive circuit section
151 electronic circuit
152 circuit cover
153 substrate
154 circuit element
160 supporting member
200 lamp
260 supporting member
300 lamp
360 supporting member
400 lamp
460 supporting member
500 lamp
560 supporting member
600, 700 lamp
750 drive circuit section
751 electronic circuit
753 substrate
754 circuit element
755 hole
800 lamp
850 drive circuit section
851 electronic circuit
853 substrate
854 circuit element
900 lamp
950 drive circuit section
1000 lamp
1070 second light emitting module
1100 lamp
1110 base
1120 globe
1130A to D light emitting module
1140 lamp housing
1141 module installation base
1150 drive circuit section
1151 electronic circuit
1152 circuit cover
1160 supporting member
1200 lamp
1270 light emitting module
1271 light guide plate
1300 lamp
1320 globe
1400 lamp
1410 base
1420 outer tube
1430 light emitting module
1440 lamp housing
1441 module installation base
1450 drive circuit section
1460 supporting member
1500 lamp
1510 base
1530 light emitting module
1540 lamp housing
1550 drive circuit section
1560 supporting member
1600 illuminating device
1610 electric apparatus
1611 socket

1. A lamp including a solid-state light emitting element as a light source, comprising:
a base configured to be attached to an external apparatus when the lamp is used and configured to be supplied with power;
a light emitting module including one or a plurality of solid-state light emitting elements; and
a drive circuit configured to light the light emitting module by using power received from the base, wherein
the base, the light emitting module, and the drive circuit are arranged in this order, and
the light emitting module is thermally connected to the base.

2. The lamp according to claim 1, wherein
the lamp further comprises a lamp housing and a globe,
the lamp housing is made of a heat conduction material, has a cylindrical shape whose outer diameter decreases from one end to the other end, and is closed with a cover on a greater outer diameter side of the cylindrical shape, a light emitting module mounting face being provided on an upper face of the cover, the base being attached to the lamp housing on a smaller outer diameter side of the cylindrical shape,
the globe is made of a translucent material and has a hollow spherical shape having an opening, the opening being connected to the lamp housing, on the light emitting module mounting face,
the light emitting module is covered with the globe,
the globe includes a diffusion film on an inner wall thereof, and
the diameter of a maximum diameter portion of the globe is greater than the diameter of a maximum diameter portion of the lamp housing.

3. The lamp according to claim 1, wherein
the lamp further comprises a supporting member, and
the drive circuit is installed by being fixed by the supporting member, in a hollow space, away from the base and the light emitting module, so as to block some of light emitted from the light emitting module.

4. The lamp according to claim 3, wherein
the drive circuit is surrounded by a circuit cover whose surface is formed by a reflective material.

5. The lamp according to claim 4, wherein
the reflective material has a reflectance of 80% or more in a wavelength range of light emitted from the light emitting module.

6. The lamp according to claim 4, wherein
the supporting member is formed by a plurality of stick-like supports, and
one ends of the supports are attached to the light emitting module mounting face so as to surround the light emitting module, and the other ends thereof are attached to the circuit cover.

7. The lamp according to claim 2, wherein
the drive circuit is arranged on an axis passing through the base and the tip of the globe.

8. The lamp according to claim 2, wherein
the lamp further comprises a supporting member, and
the supporting member is either one of a stick-like support and a translucent tube which each fix the drive circuit to the lamp housing, or either one of a prop and a translucent adhesive member which each fix the drive circuit to the inner wall of the globe.

9. The lamp according to claim 1, wherein
the drive circuit includes a substrate and a circuit element mounted on the substrate, and
a hole for allowing light pass therethrough is formed in the substrate.

10. The lamp according to claim 1, wherein
the drive circuit includes a substrate and a circuit element mounted on the substrate, and
a base material of the substrate has translucency.

11. The lamp according to claim 1, wherein
the drive circuit includes a substrate and a circuit element mounted on the substrate, and
the substrate is installed such that the mounting face thereof is substantially parallel to an emission direction of the light emitting module.

12. The lamp according to claim 1, wherein
the lamp further comprises a light guide plate configured to guide some of light emitted from the light emitting module to a portion where light is blocked by the drive circuit.

13. The lamp according to claim 1, wherein
the lamp further comprises a globe having a light guiding function that guides some of light emitted from the light emitting module to a portion where light is blocked by the drive circuit.

14. The lamp according to claim 1, wherein
the lamp further comprises a second light emitting module configured to emit light to a portion where light is blocked by the drive circuit, and having an output smaller than that of the light emitting module.

15. An illuminating device comprising:
a lamp including a solid-state light emitting element as a light source, and
an electric apparatus to which the lamp is attached and which supplies power from a commercial power source, wherein
the lamp includes:
a base configured to be attached to an external apparatus when the lamp is used and configured to be supplied with power;
a light emitting module including one or a plurality of solid-state light emitting elements, and
a drive circuit configured to light the light emitting module by using power received from the base,
the base, the light emitting module, and the drive circuit are arranged in this order,
the light emitting module is thermally connected to the base, and
the electric apparatus includes a socket to which the base is connected.
